(19) United States
(12) Patent Application Publication
(10) Pub. No.: US 2009/0273391 A1
(43) Pub. Date: Nov. 5, 2009

(54) FLASH MEMORIES AND REGULATED VOLTAGE GENERATORS THEREOF

(76) Inventors: Te-Chang TSENG, Hsinchu County (TW); Chun-Yi Tu, Hsinchu City (TW); Yamasaki Kyoji, Takarazuka City (JP)

Correspondence Address: Muncy, Geissler, Olds & Lowe, PLLC, P.O. BOX 1364, FAIRFAX, VA, 22038-1364, US

(21) Appl. No.: 12/434,151

(22) Filed: May 1, 2009

(30) Foreign Application Priority Data
May 2, 2008 (TW) 97116206

(51) Int. Cl. G05F 1/10

(52) U.S. Cl. 327/536

(57) ABSTRACT

A flash memory and a regulated voltage generator thereof. The regulated voltage generator includes a charge pump having an output terminal outputting a first voltage, a control circuit coupled to the output terminal of the charge pump and having first and second output terminals outputting a second voltage and a charge pump control signal, respectively, and a Field Effect Transistor (FET) in diode mode. The FET is coupled between the output terminal of the charge pump and the first output terminal of the control circuit. The charge pump adjusts the first voltage according to the charge pump control signal.

### CROSS REFERENCE TO RELATED APPLICATIONS

This Application claims priority of Taiwan Patent Application No. 97116206, filed on May 2, 2008, the entirety of which is incorporated by reference herein.

### BACKGROUND OF THE INVENTION

1. Field of the Invention

The present invention relates to flash memories and regulated voltage generators thereof. The regulated voltage generators are applied to providing voltage signals for write line drivers of the flash memory.

2. Description of the Related Art

To read/write data from a memory cell of a flash memory, a large read/write enable voltage, as large as 26 volts, has to be imposed on a gate terminal of the memory cell. A write line driver is designed to transit the read/write enable voltage to the gate terminal of the memory cell. FIG. 1 illustrates a conventional technique providing a memory cell 104 of a flash memory with a read/write enable voltage. As shown in FIG. 1, a write line driver 102 comprises a Field Effect Transistor (FET) M. Controlled by a first voltage V₁, the FET M transits a second voltage V₂ into the memory cell 104 as the read/write enable voltage. A charge pump 106 and two conventional voltage regulators 108 and 110, are designed to provide the two voltages V₁ and V₂. The charge pump 106 outputs two signals 112 and 114 to be processed by the two voltage regulators 108 and 110, respectively, to generate regulated voltages V₁ and V₂ for the write line driver 102.

The conventional technique shown in FIG. 1 requires two separate voltage regulators to ensure the accuracy of the voltages V₁ and V₂. Thus, providing distinct and accurate voltages by a single circuit is one area of interest for those skilled in the art.

### BRIEF SUMMARY OF THE INVENTION

The invention discloses regulated voltage generators. The regulated voltage generator comprises a charge pump, a control circuit and a field effect transistor (FET). The charge pump has an output terminal outputting a first voltage, and receives a charge pump control signal to adjust the first voltage. The control circuit is coupled to the output terminal of the charge pump and has a first and a second output terminal. The control circuit outputs a second voltage via the first output terminal, and outputs the charge pump control via the second output terminal. The FET is operated in a diode mode and is coupled between the output terminal of the charge pump and the first terminal of the control circuit.

An exemplary embodiment of the regulated voltage generator of the invention further comprises a bias circuit. The bias circuit generates a third voltage to bias the base of the FET. The bias circuit may change the value of the third voltage to suit different conditions.

The invention further discloses flash memories comprising the aforementioned regulated voltage generators. The flash memory comprises a memory cell, a write line driver, a charge pump, a control circuit and a first FET. The write driver is enabled by a first voltage to transit a second voltage to the memory cell. The charge pump has an output terminal outputting the first voltage, and receives a charge pump control signal to adjust the first voltage. The control circuit is coupled to the output terminal of the charge pump and has a first and a second output terminal. The control circuit outputs a second voltage via the first output terminal, and outputs the charge pump control via the second output terminal The first FET is operated in a diode mode and is coupled between the output terminal of the charge pump and the first output terminal of the control circuit.

The write line driver of the flash memory may comprise a second FET, enabled by the first voltage to pass the second voltage. The first and second FETs may be identical (made of identical manufacturing processes or of the same channel width to length ratio).

An exemplary embodiment of the flash memory of the invention further comprises a bias circuit. The bias circuit generates a third voltage to bias the base of the first FET. The bias circuit may change the value of the third voltage to suit different conditions.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 illustrates a partial structure of a conventional flash memory;

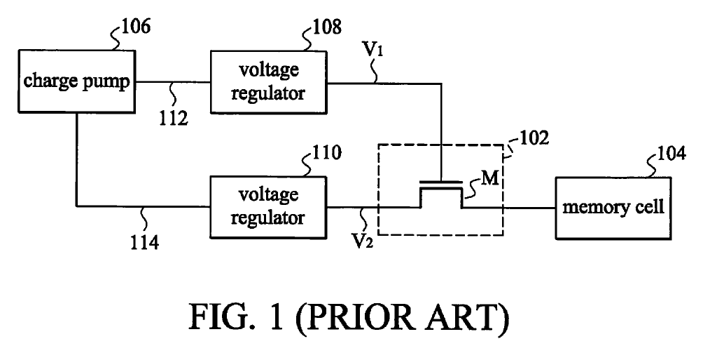

FIG. 2 illustrates an embodiment of regulated voltage generators of the invention;

FIG. 3 illustrates another embodiment of regulated voltage generators of the invention;

FIG. 4 illustrates an embodiment of bias circuits of the invention;

FIG. 5 illustrates an embodiment of flash memories of the invention; and

FIG. 6 illustrates another embodiment of flash memories of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

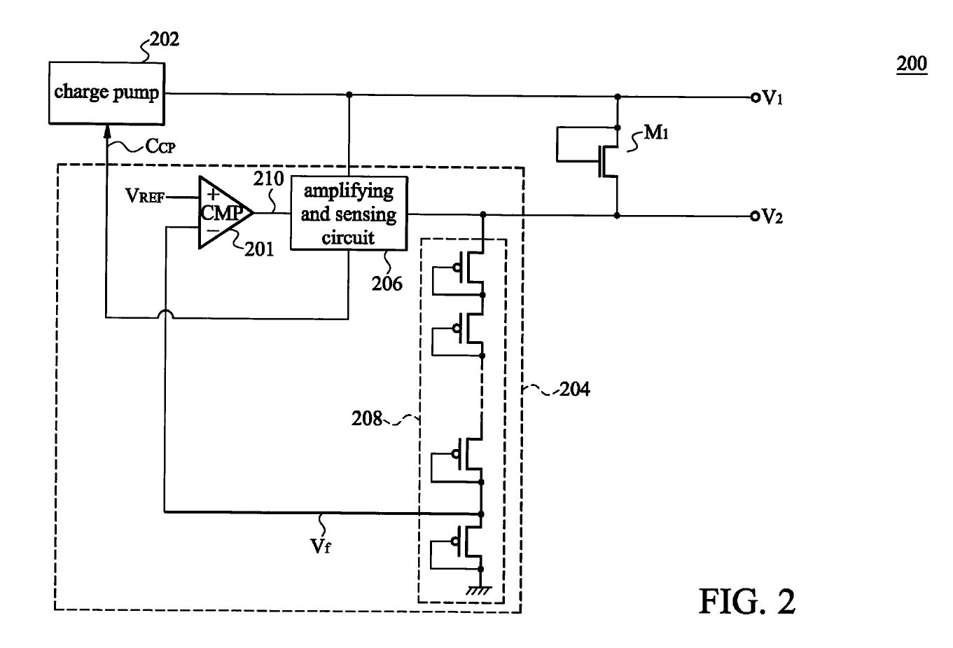

FIG. 2 illustrates an embodiment of regulated voltage generators of the invention. The regulated voltage generator 200 comprises a charge pump 202, a control circuit 204 and a Field Effect Transistor (FET) M₁. The charge pump 202 has an output terminal outputting a first voltage V₁. The control circuit 204 couples to the output terminal of the charge pump 202, and has a first and second terminal outputting a second voltage V₂ and a charge pump control signal Cₑₚ, respectively. The FET M₁ is in a diode mode and coupled between the output terminal of the charge pump 202 and the first output terminal of the control circuit 204.

The control circuit 204 outputs the second voltage V₂ and the charge pump control signal Cₑₚ according to the first voltage V₁. The charge pump control signal Cₑₚ is sent into the charge pump 202, and the charge pump 202 adjusts the value of the first voltage V₁ according to the charge pump control signal Cₑₚ. The aforementioned components form a loop to constantly maintain the first and second voltages V₁ and V₂. Meanwhile, because of connection via the FET M₁, the first and second voltages V₁ and V₂ fluctuate simultaneously. Thus, the first and second voltages V₁ and V₂ simultaneously reach their target values. Compared with conventional techniques, the regulated voltage generator of the invention requires much shorter reaction time, outputs synchronous voltages (V₁ and V₂), and has high accuracy.

As shown in the embodiment of FIG. 2, the control circuit 204 comprises an amplifying and sensing circuit 206, a voltage divider 208 and a comparator 201. The amplifying and sensing circuit 206 has two input terminals receiving a control signal 210 and the first voltage V₁, respectively, and has two output terminals outputting the second voltage V₂ and the charge pump control signal Cₑₚ, respectively. The voltage divider 208 divides the second voltage V₂ to generate a feedback voltage V_{f}. The comparator 201 compares the feedback voltage V_{f} with a reference voltage V_{ref} to generate the control signal 210. The control circuit 204 may be realized by other techniques and is not limited to the structure shown in FIG. 2.

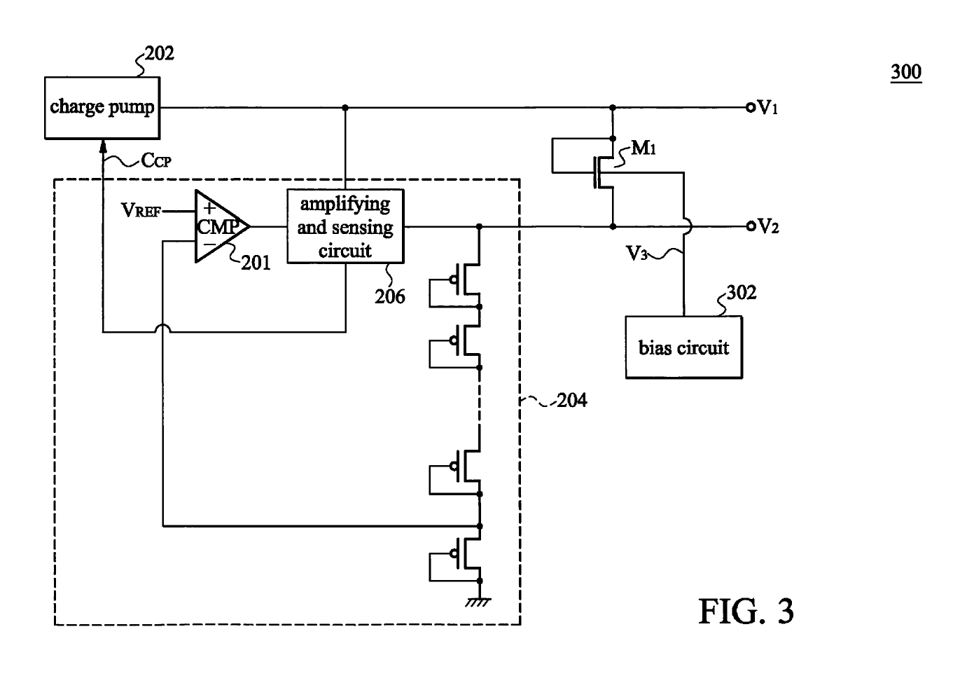

The FET M₁ may breakdown if the base of the FET M₁ is biased at 0V and the first voltage V₁ operates at a large voltage level. To prevent the FET M₁ from breaking down, the regulated voltage generator of the invention may further comprise a bias circuit. FIG. 3 shows one example of this kind of regulated voltage generators. Compared to the regulated voltage generator 200 of FIG. 2, the regulated voltage generator 300 of FIG. 3 further comprises a bias circuit 302 generating a third voltage V₃ to bias the base of the FET M₁. The bias circuit 302 prevents the FET M₁ from breaking down.

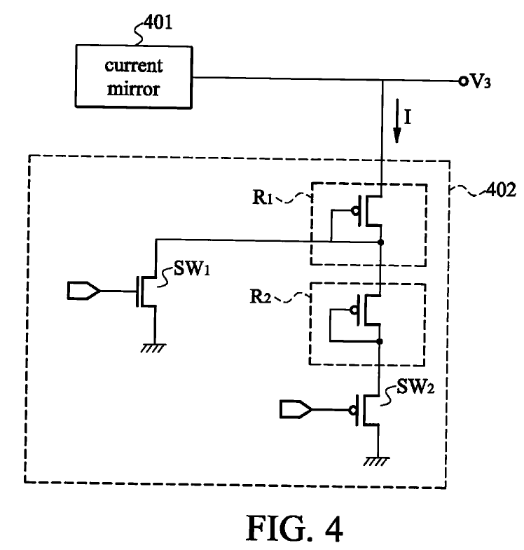

The bias circuit 302 may comprise a current mirror and a resistor. The current mirror provides the resistor with a current to generate the third voltage V₃. The bias circuit 302 may change the value of the third voltage V₃ to suit different conditions. FIG. 4 illustrates an embodiment of the bias circuit, which comprises a current mirror 401 and a resistor 402. The current mirror 401 outputs a current I to flow through the resistor 402 to generate the third voltage V₃. The resistor 402 comprises a plurality of resistor elements R₁ and R₂ and a plurality of switches SW₁ and SW₂. The resistor elements R₁ and R₂ are coupled in series and are coupled to the ground by the switches SW₁ and SW₂, respectively. The value of the third voltage V₃ is changed by switching the switches SW₁ and SW₂. The resistor elements R₁ and R₂ may be realized by diode mode FETs (as shown in FIG. 4). The circuit of the resistor 402 does not limit the scope of the invention, and it can be replaced by any substitute.

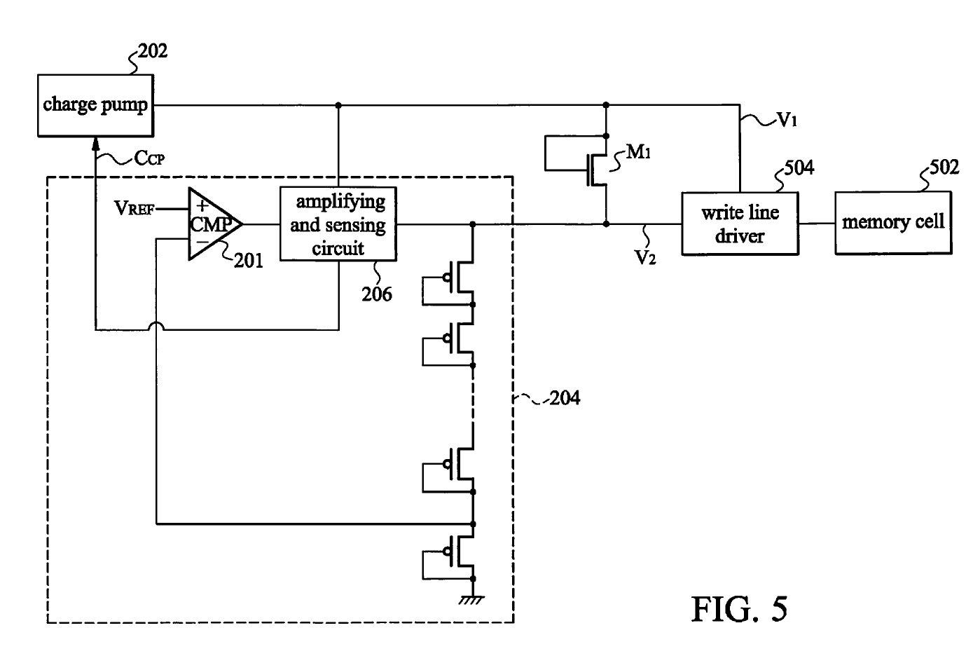

The invention further discloses flash memories comprising the aforementioned regulated voltage generators. FIG. 5 illustrates an embodiment of the flash memory, which comprises a memory cell 502, a write line driver 504, a charge pump 202, a control circuit 204 and a first FET M₁. The write line driver 504 is enabled by a first voltage V₁ to transit a second voltage V₂ to the memory cell 504 as the read/write enable voltage. The charge pump 202 has an output terminal outputting the first voltage V₁. The control circuit 204 is coupled to the output terminal of the charge pump 202 and has a first and second output terminal outputting the second voltage V₂ and a charge pump control signal Cₑₚ, respectively. The first FET M₁ is in a diode mode and is coupled between the output terminal of the charge pump 202 and the first output terminal of the control circuit 204.

The control circuit 204 outputs the second voltage V₂ and the charge pump control signal Cₑₚ according to the first voltage V₁. The charge pump control signal Cₑₚ is sent into the charge pump 202, and the charge pump 202 adjusts the value of the first voltage V₁ according to the charge pump control signal Cₑₚ. The charge pump 202, the control circuit 204 and the first FET M₁ form a loop to ensure the accuracy and the speed of convergence of the first and second voltages V₁ and V₂, and generates ideal V₁ and V₂ for the write line driver 504.

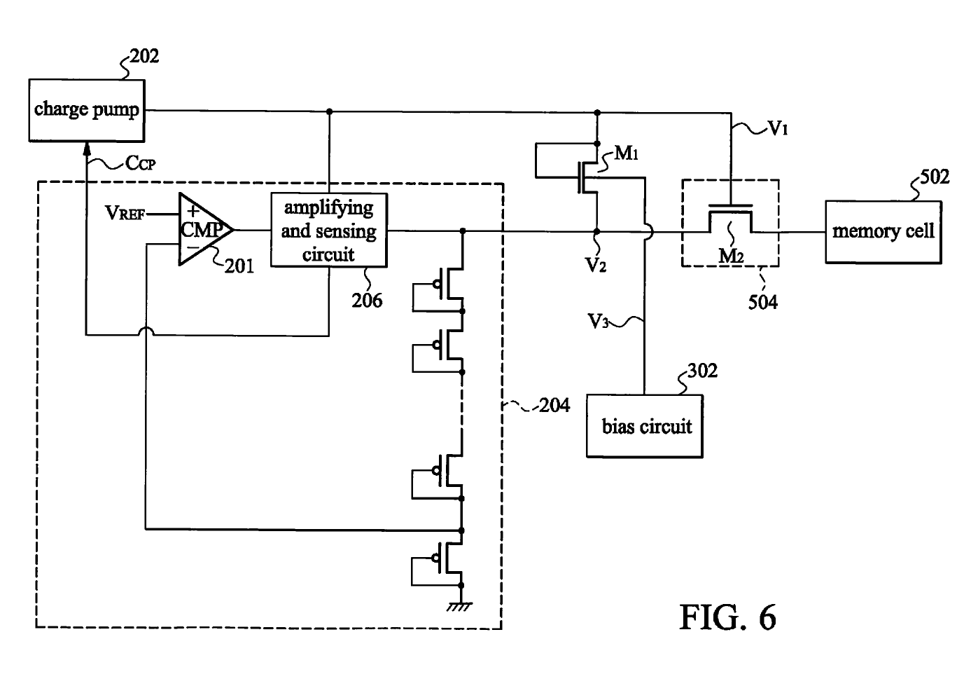

The write line driver 504 may comprise a FET (named ‘second FET’ hereinafter) in which the gate is controlled by the first voltage V₁ and the drain or source is coupled to the second voltage V₂. The size or the manufacturing process of the second FET may be identical to that of the first FET M₁, so that the second FET may breakdown under improper operations. Because the read/write enable voltage required is very large, such as 26 volts, the second voltage V₂ is designed to be very large. To enable the second FET, the first voltage V₁ is designed to be larger than the second voltage V₂. For example, the first voltage V₁ is designed to be 31 volts when the second voltage V₂ is designed to be 26 volts. In such a case, the first FET M₁ may breakdown if the base of the FET M₁ is biased at 0V. FIG. 6 illustrates an embodiment of flash memories of the invention, wherein a bias circuit 302 is utilized to prevent the first FET M₁ from breaking down. The bias circuit 302 generates a third voltage V₃ to bias the base of the first FET M₁ to ensure the voltage difference between the source/drain and the base of the first FET M₁ within a reasonable range. Thus, the bias circuit 302 prevents the FET M₁ from breaking down. One of the embodiments of the bias circuit is shown in FIG. 4.

In addition to providing accurate and real-time voltages V₁ and V₂ for the write line driver 504, the flash memory shown in FIG. 6 further provides a solution to the breakdown problem of the first FET M₁.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A regulated voltage generator, comprising
a charge pump, having an output terminal outputting a first voltage, and adjusting the first voltage according to a charge pump control signal;
a control circuit, coupled to the output terminal of the charge pump, and having first and second output terminals outputting a second voltage and the charge pump control signal, respectively, wherein the second voltage and the charge pump control signal are generated according to the first voltage; and
a field effect transistor, working in a diode mode and coupled between the output terminal of the charge pump and the first output terminal of the control circuit.

2. The regulated voltage generator as claimed in claim 1, further comprising a bias circuit generating a third voltage to bias a base of the field effect transistor.

3. The regulated voltage generator as claimed in claim 2, wherein the bias circuit comprises:
a current mirror, providing a current; and
a resistor, receiving the current to generate the third voltage.

4. The regulated voltage generator as claimed in claim 3, wherein the resistor has variable resistance.

5. The regulated voltage generator as claimed in claim 4, wherein the resistor comprises:
a plurality of resistor elements, coupled in series; and
a plurality of switches, coupling the resistor elements to ground, respectively.

6. The regulated voltage generator as claimed in claim 5, wherein each of the resistor elements is a diode mode FET.

7. The regulated voltage generator as claimed in claim 1, wherein the control circuit comprises:
an amplifying and sensing circuit, coupled to the output terminal of the charge pump, receiving a control signal, and generating the second voltage and the charge pump control signal;
a voltage divider, dividing the second voltage to generate a feedback voltage; and
a comparator, comparing the feedback voltage with a reference voltage to generate the control signal for the amplifying and sensing circuit.

8. A flash memory, comprising:
a memory cell;
a write line driver, enabled by a first voltage to transit a second voltage to the memory cell;
a charge pump, having an output terminal outputting the first voltage, and adjusting the first voltage according to a charge pump control signal;
a control circuit, coupled to the output terminal of the charge pump, and having first and second output terminals outputting the second voltage and the charge pump control signal, respectively, wherein the second voltage and the charge pump control signal are generated according to the first voltage; and
a first field effect transistor, working in a diode mode and coupled between the output terminal of the charge pump and the first output terminal of the control circuit.

9. The flash memory as claimed in claim 8, wherein the write line driver comprises a second field effect transistor enabled by the first voltage to transit the second voltage.

10. The flash memory as claimed in claim 9, wherein the first and second field effect transistors are made of an identical manufacturing process or have identical sizes.

11. The flash memory as claimed in claim 9, further comprising a bias circuit generating a third voltage to bias a base of the first field effect transistor.

12. The flash memory as claimed in claim 11, wherein the bias circuit comprises:
a current mirror, providing a current; and
a resistor, receiving the current to generate the third voltage.

13. The flash memory as claimed in claim 12, wherein the resistor has variable resistance.

14. The flash memory as claimed in claim 13, wherein the resistor comprises:
a plurality of resistor elements, coupled in series; and
a plurality of switches, coupling the resistor elements to ground, respectively.

15. The flash memory as claimed in claim 14, wherein each of the resistor elements is a diode mode FET.

16. The flash memory as claimed in claim 8, wherein the control circuit comprises:
an amplifying and sensing circuit, coupled to the output terminal of the charge pump, receiving a control signal, and generating the second voltage and the charge pump control signal;
a voltage divider, dividing the second voltage to generate a feedback voltage; and
a comparator, comparing the feedback voltage with a reference voltage to generate the control signal for the amplifying and sensing circuit.
